(19) United States
(12) Patent Application Publication
(10) Pub. No.: US 2026/0192136 A1
(43) Pub. Date: Jul. 9, 2026

(54) MULTIPLE BRIDGE LINE CLIMBING SADDLE

(71) Applicant: AVID STRATEGIC LLC, Frankenmuth, MI (US)

(72) Inventor: Scott Lee, Frankenmuth, MI (US)

(21) Appl. No.: 19/442,764

(22) Filed: Jan. 7, 2026

Related U.S. Application Data
(60) Provisional application No. 63/742,525, filed on Jan. 7, 2025.
(60) Provisional application No. 63/924,481, filed on Nov. 24, 2025.

(51) Int. Cl. A62B 35/00

(52) U.S. Cl. CPC A62B 35/0012; A62B 35/0031; A62B 35/0037

(57) ABSTRACT

An improved tree saddle assembly includes a saddle configured to wrap about a user for support while tethered to a tree by a tether line. A bridge line assembly provides two distinct, forward-extending loops: a first bridge line coupled to left and right attachment locations on a first portion of the saddle, and a separate second bridge line coupled to left and right attachment locations on a second portion of the saddle. Each bridge line forms a loop with an apex configured for attachment to the tether line. The first and second bridge line loops are independently adjustable in effective length, enabling selective repositioning of the saddle's first and second portions relative to one another while the user remains tethered. This independent adjustability permits fine-tuned balance and comfort adjustments, improving load distribution and user positioning without requiring disengagement from the tether.

### CROSS-REFERENCE TO RELATED APPLICATIONS

This U.S. Utility application claims the benefit of U.S. Provisional Application Ser. No. 63/742,525, filed Jan. 7, 2025, and U.S. Provisional Application Ser. No. 63/924,481, filed Nov. 24, 2025, the disclosures and drawings of both of which are incorporated herein by reference in their entirety.

### BACKGROUND OF THE INVENTION

### 1. Technical Field

This invention relates generally to climbing saddles for climbing trees and the like and more particularly to the construction and operation of the bridge line assemblies of climbing saddles that connect with a tether line to support the user in the saddle while tethered to the tree.

### 2. Related Art

Climbing saddles are worn by tree climbers, including saddle hunters, as a means to securely and comfortably climb a tree and support their body tethered to a tree when reaching the desired height while engaging in an activities such as bow hunting and the like. The climbing saddle includes a fabric panel that cradles the user's hips, thighs and lower back and has left-side and right-side attachment loops for connecting a bridge line. The bridge line is typically a length of rope that is hitched at its ends to the left and right-side loops of the saddle and it presents a large loop that extends forwardly of the user for attachment to a tree tether rope by a carabiner or the like for securely tethering the user in the tree while hunting.

Those that saddle hunt for extended periods of time may begin to experience discomfort from sitting in one position in the saddle. The user may experience pressure points applied to one or more parts of the hunter's body from the tethered saddle. Often some or all of the discomfort can be relieved by shifting the user's weight or position in the saddle. The bridge line is typically provided with a length adjustment for moving the user toward or away from the carabiner. But there is a risk in moving in the saddle since movements to adjust for comfort risks making noise and otherwise drawing unwanted attention from the game they are hunting if not done carefully, quietly and with minimal movement. Some saddle adjustment systems are deficient in that they do not allow for much range of adjustment and they may also require the user to fully or partially unweight the saddle for adjustment. There is a need in the industry for an improved saddle that addresses these deficiencies.

### SUMMARY

According to a first aspect, a tree saddle assembly comprises a saddle wrappable about a user for supporting the user while tethered in a tree from a tether line. A bridge line assembly is provided including a first bridge line loop extending forward of the saddle to an apex for attachment to the tether line and coupled to a first set of left and right attachment locations of a first portion of the saddle, and at least a second bridge line loop separate from the first bridge line loop and extending forward of the saddle to an apex for attachment to the tether line and coupled to a second set of left and right attachment locations of a second portion of the saddle. The first and second bridge line loops are independently adjustable in effective length to enable the user to adjust the positions of the first and second portions of the saddle relative to one another while tethered in the tree.

According to a further aspect, a tree saddle assembly is provided, comprising a saddle fabricated of one or more interconnected panels of flexible material configured to wrap behind the body of a user to provide weighted support to the user while tethered in the tree by a tether line. The saddle has at least an upper section and a lower section and extending between left and right sides that are presented on left and right sides of the user, respectively, when in use. At least two bridge lines connect the saddle to the tether line when in use, comprising an upper bridge line connected to the left and right sides of the upper section of the saddle and extending forward of the saddle in an upper loop connectable at apex thereof to the tether line when in use, and a lower bridge line connected to left and right sides of the lower portion of the saddle and extending forward of the saddle in a lower loop connectable at an apex thereof to the tether line, the upper and lower loops being free to slide relative to the tether line and to move relative to one another in use. The upper and lower loops are adjustable in effective length independently of one another.

According to a further aspect, a method is provided of adjusting the position of upper and lower sections of a tree saddle supporting a user while tethered from a tree by a tether line. The method includes providing the saddle with at least two separate bridge lines including an upper bridge line fixed against adjustment at one to the left or right side of an upper section of the saddle and connected adjustably to the other right or left side of the saddle by an upper length adjustment device, and further providing the saddle with a lower bridge line separate from the upper bridge line that is fixed against adjustment at one end to the left or right side of a lower section of the saddle at a different location than the fixed end of the upper bridge line and connected adjustably to the other right or left side of the saddle by a lower length adjustment device at a different location than the location of the upper adjustment device. Forward loops of the of the upper and lower bridge lines are connected with slidable support to tether line (such as by a carabiner) such that the upper and lower tether lines are able to glide relative to the tether line and move relative to and independently of one another. The user manipulates the upper and lower adjustment device independently of one another so as to increase or decrease the effective lengths of the loops of the upper and lower bridges relative to the connection point with the tether line so as to move the upper and lower sections of the saddle closer to or further from the connection point to adjust the tile angle of the saddle relative to the tree, to adjust the angle between the upper and lower saddle sections, and to adjust the distribution of the user's weight between the upper and lower bridge lines.

The multiple bridge line leads have the advantage of enabling the user to easily and discretely adjust the loading profile of the saddle in multiple areas as needed to alleviste pinch points or to shift the user's weight in the saddle to increase comfort by simply decreasing or increasing the effective length of one or both bridge lines. For example, if the first bridge line is attached to the seat/hip portion of the saddle and if the second bridge line is attached to the back portion, the user can pull on a tag end of the first bridge line to decrease the effective length of the first bridge line and draw the seat portion toward the tree to swing the seat portion upwardly. In addition, the user could increase the effective length of the second bridge line which would act to drop the back portion downward. It will be appreciated that various combinations of adjustments of the two bridge lines are possible (one line increased in length while the other is decreased, both increased in length, both decreased in length) and by varying amounts that result in near infinite adjustability.

A further advantage of multiple bridge lines, in addition to greatly enhanced adjustability, is that it adds redundancy to the support of the user. Instead of relying on a single bridge line to support the user while saddled in the tree, there is at least a second bridge line. In the unfortunate event that one of the bridge lines or anchor points were to fail or otherwise not perform as intended, the other bridge line is present as a backup.

A further advantage of having multiple bridge lines, in addition to enhanced adjustability, is that the weight of the user is distributed across the multiple lines. As such, no single bridge line is bearing the full weight of the user. This reduces the load requirement and an enable the saddle assembly to have thinner, lighter load bridge lines that collectively can support the load. A further advantage of distributing the load is that the magnitude of static forces that would otherwise act on a given point are distributed to other points, thus increasing the overall comfort of the saddle. The near infinite adjustability further enhances the ability to shift the user's weight around to relieve any discomfort or to position and support the user in a position advantageous for shooting at an intended target, for example.

The adjustments can be made very discretely, with just a simple action of pulling up on a tag end to decrease the length of a bridge line or pulling down on a friction hitch knot or slider or other device to increase the effective length. Being discrete, quiet, smooth and deliberate is important in some circumstances such as when hunting wild game from a tethered saddle.

A further feature is that the saddle assembly can be configured from the use condition to a compact walking condition for wearing while walking into and out of the woods. In a preferred form, the saddle can be folded upon itself (in half, for example, to create a fold) and wrapped about the users waist like a belt when in the walking condition. The belt line of the saddle can be tightened about the user's waist and the first and second bridge lines can be drawn tight by pulling on their tag ends to further cinch the saddle about the user's waist. The extended tag ends can be tucked into the fold of the saddle. The leg straps can be stowed within the fold of the saddle created by folding the saddle upon itself. This compact walking condition makes for a very tight, neat, small configuration that is very attractive and efficient. It also minimizes loose fabric that may snag on brush and the like while walking. The fold of the saddle also creates a pouch for storage of items that might otherwise need to be carried or stowed elsewhere, such as the lineman's rope, etc. A further feature of the folded saddle walking configuration is that the saddle can be fitted with a closure to help maintain the folded portions in the overlapped position. Closures can include magnets which can be embedded in the saddle and releasably secure the saddle in the folded condition. In the preferred embodiment, the upper part of the saddle is attached to the user as it would be in use by use of a cinched belt line and the lower part of the saddle as folded upward so as to orient the inside of the lower part outward. The magnets are brought into engagement to maintain the folded state and the bridge lines are then tightened and tucked to secure the saddle to the user's waist. The leg straps may also be tucked or stowed in the pocket formed by the folded saddle portions.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a perspective view of a first embodiment of a saddle assembly; and

FIG. 2 is front perspective view of the assembly of FIG. 1;

FIG. 3 is a right side perspective of the assembly shown supporting a user;

FIG. 4 is a view like FIG. 3 showing the user adjusting the lower bridge line;

FIG. 5 is enlarged fragmentary right side perspective view showing the user adjusting the upper bridge line;

FIG. 6 is a view like FIG. 3 showing the user adjusting the lower bridge line;

FIG. 7 is a view like FIG. 3 showing the saddle adjusted to a reclined position;

FIG. 8 is a right side perspective of the saddle in a folded walking condition;

FIG. 9 is a front perspective view of the saddle shown in the walking condition and supported on the user;

FIG. 10 is a rear perspective view of the saddle in the folded walking condition shown supported on the user;

FIG. 11 is a perspective view of another embodiment of a saddle assembly; and

FIG. 12 is an enlarged fragmentary perspective view of a portion of the saddle assembly of FIG. 11.

### DETAILED DESCRIPTION OF PREFERRED EMBODIMENTS

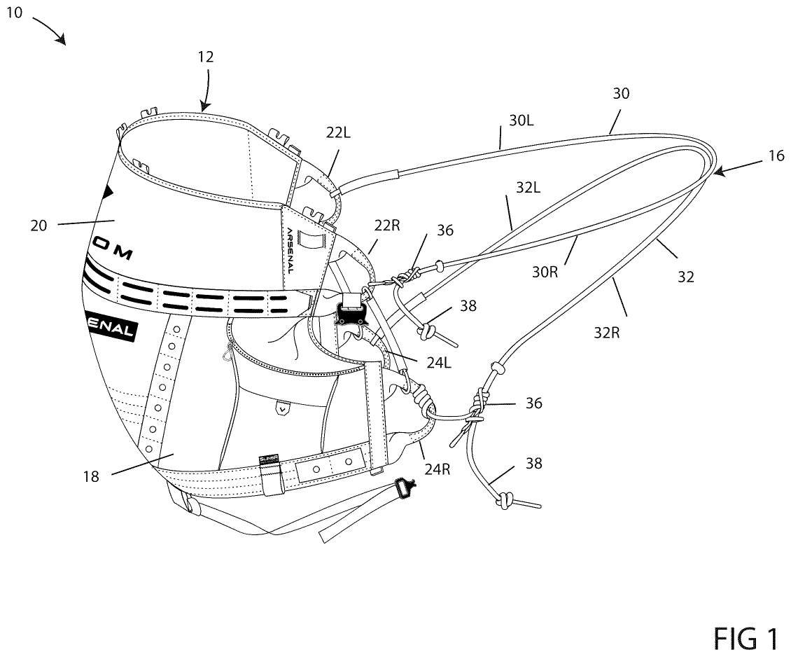

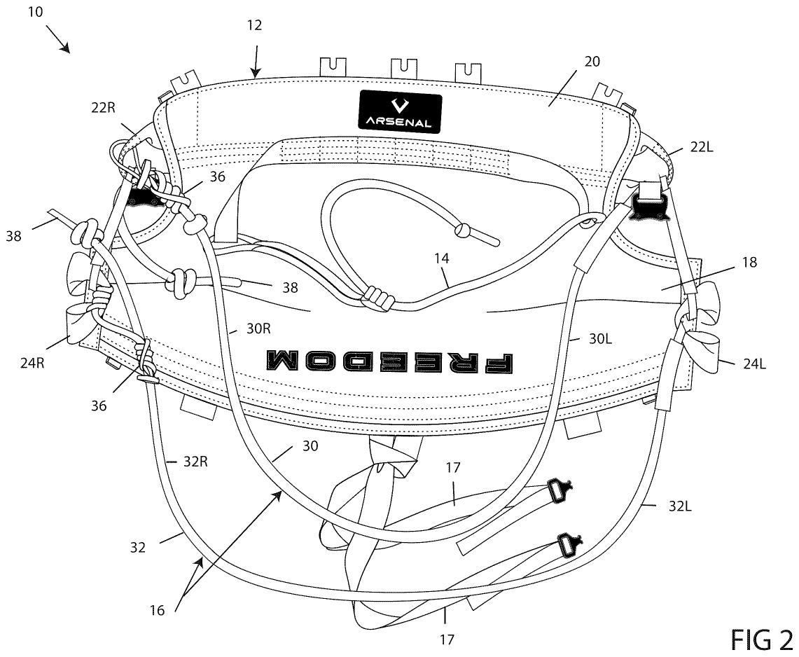

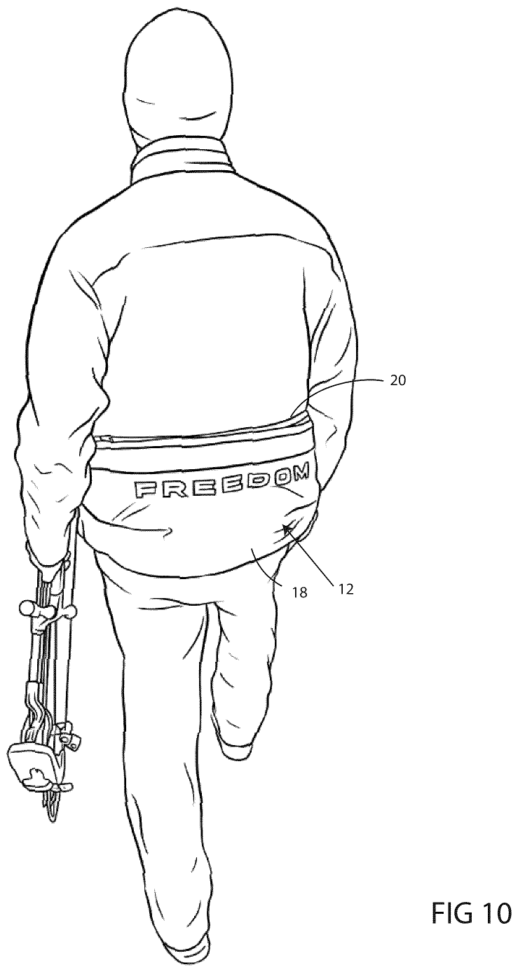

FIGS. 1-10 illustrate an exemplary and non-limiting embodiment(s) of a saddle assembly 10 shown in different views and positions that includes a saddle 12, a waist belt 14, a bridge line assembly 16 and leg straps 17.

The saddle 12 has flexible fabric panels which are sewn together to form a sling for supporting a user, such as a saddle hunter. The saddle has at least a lower portion 18 and an upper portion 20. The portions 18, 20 may be regions of a solid panel or they may be separate sections or parts that are spaced from one another and joined to one another across the space by straps or the like. The lower portion 18 extends between left and right sides and may wrap about the thigh, buttocks and hip regions of the user. The upper portion 20 extends between left and right sides and may wrap about the back of the user. Additional sections may be provided but for illustrative purposes it is understood that the saddle 12 will include at least a lower portion 18 and an upper portion 20 that support different upper and lower regions of the user's body.

The left and right sides of the upper and lower saddle portions 18, 20 include bridge line attachments 22L, 22R and 24L, 22R for connection with the bridge line assembly 16 in a manner to be described below. The bridge line attachments 22L, 22R and 24L, 24R may comprise bridge line attachment loops that form an integral part of the saddle portions and may be made of webbing material. The waist belt 14 extends about the waist of the user and is adjustable in effective length to tighten the belt 14 about the waist to support the saddle on the user. The leg straps 17 wrap about the user's thighs and may attach to the saddle at their free ends by releasable clips or the like to form leg loops. The leg straps 17 are adjustable to fit snuggly but comfortably about the user's thighs.

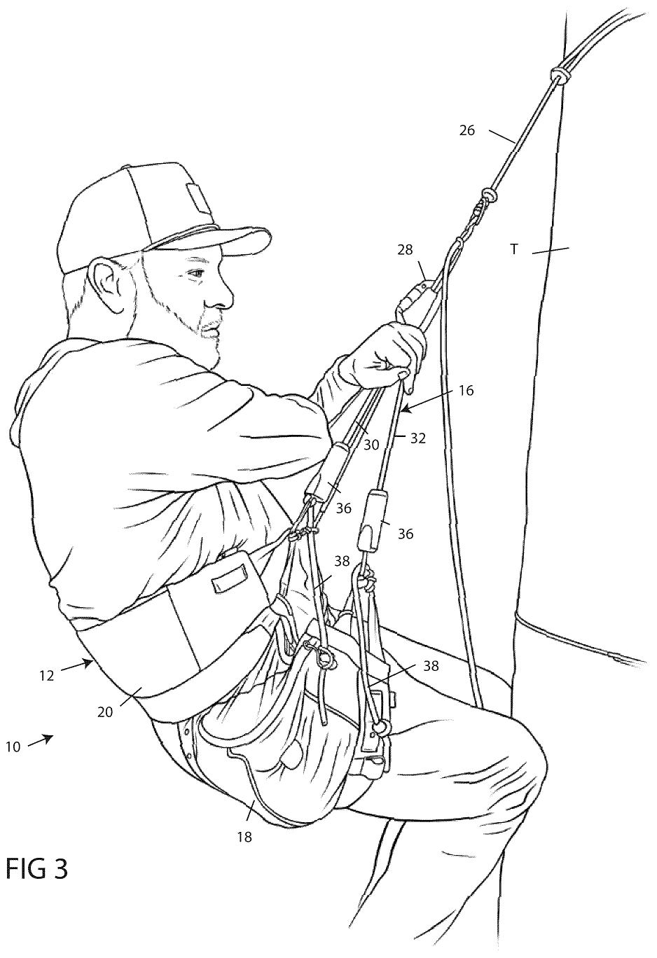

As particularly shown further in FIG. 3-7, the saddle assembly 10 is used in combination with a tether line 26 which is tied to a tree T or pole at a location above the saddle assembly 10 and typically supports a carabiner clip 28 its free end which hangs down toward the user. The bridge line assembly 16 is connected to the left and right sides of the saddle 12 and forms at least one loop extendable forwardly of the saddle 12 for selective attachment in use to the carabiner 28 of the tether line 26. More particularly, the bridge line assembly 16 has a first set of left 30L and right 30R bridge line leads and at least a second set of left 32L and right 32R bridge line leads. The first set of bridge line leads 30L, 30R are connected to the associated first set of left 22L and right 22R attachment locations or bridge line loops of the saddle 12 and the second set of bridge line leads 32L, 32R are attached to the associated second set of left 24L and right 24R attachment locations or bridge line loops of the saddle 12 that are distinct from the first set of attachment locations 22L, 22R. The first and second bridge line leads 30L, 30R; 32L, 32R have effective lengths between their respective attachment locations that are independently adjustable to enable the user to change the position of the saddle 12 in use. The carabiner 28 and the left and right attachment points of the saddle form a triangulated suspension support with the bridge line leads, and adjusting the length of the bridge line changes the effective length of the leads to move the attachment locations toward or away from the carabiner 28 and in doing so adjusts the position of the saddle 12. The subject bridge line assembly 16 and its multi-contact support provide a significant range of length adjustment and distribution of the loads to maximize adjustability and comfort for the user, as will be explained in more detail below.

According to a preferred embodiment, the bridge line assembly comprises multiple bridge lines in the preferred form of an upper bridge line 30 having the bridge line leads 30L, 30R and a lower bridge line 32 having the bridge line leads 32L, 32R. In other words, the preferred embodiment includes at least two bridge lines 30, 32, but there could be additional bridge lines that connect with other regions of the saddle 12. The upper bridge line 30 is connected adjacent a left end thereof to the left attachment location or loop 22L and adjacent its right end thereof to the right attachment location or loop 22R. The upper bridge line 30 forms a bridge line loop extending forwardly of the saddle 12 and connectable to the carabiner clip 28. The lower bridge line 32 is connected adjacent a left end thereof to the left attachment location or loop 24L and adjacent its right end to the right attachment location or loop 24R. The lower bridge line 32 forms a bridge line loop extending forwardly of the saddle 12 and is connectable to the carabiner clip 28. As such, the saddle is connected to the tether line 26 by at least two bridge lines 30 and 32.

The upper and lower bridge lines 30, 32 are each adjustable in their effective lengths independently of one another. The bridge line length adjustment may comprise sliding friction hitches 36 that may be provided on each of the bridge lines 30, 32. The hitches 36 may comprise sliding friction hitch knots with it being appreciated that any type of knot or device that permits sliding for adjustment while the user is supported in the saddle and then cinches tight when under tension to maintain position would be suitable and contemplated herein. One preferred sliding hitch is a catalyst hitch knot. As illustrated, the sliding hitches 36 may be provided adjacent the left or right attachment loops of the saddle 12 where the bridge lines 30, 32 connect to the saddle 12. The opposite (left) ends of the bridge lines 30, 32 are fixed to the saddle and are preferably not adjustable. In other words, adjustment of each of the upper and lower bridge lines 30, 32 is achieved from one side (illustrated as the right side) of the saddle 12 by a single adjustment device 36 associated with each bridge line 30, 32. Adjusting the effective length of the bridge lines 30, 32 increases or decreases the size of the respective bridge line loops connected to the carabiner clip 28. The loops triangulate between the carabiner clip 28 and their connection points with the saddle 12. Increasing the effective length lengthens the legs of the triangle formed by the bridge line and allows the associated attachment locations to move further away from the carabiner clip 28 causing the associated portion of the saddle 12 to lower or drop. The opposite happens when the effective length is shortened, whereas the legs of the triangle are shortened and the associated portions of the saddle 12 are raised or pulled closer to the carabiner clip 28.

In use, the user installs the saddle 12 by stepping through the leg straps 17 and tightening the straps 17 and waist belt 14 about the user's thighs and waist. The loops of the upper and lower bridge lines 30, 32 are connected to the carabiner clip 28 of the tether line 26 and the user sits back with the thighs and hips supported by the lower portion 18 of the saddle 12 and the user's back supported by the upper portion 20 of the saddle 12, as illustrated in FIG. 3 which shows an initial position of the saddle 12.

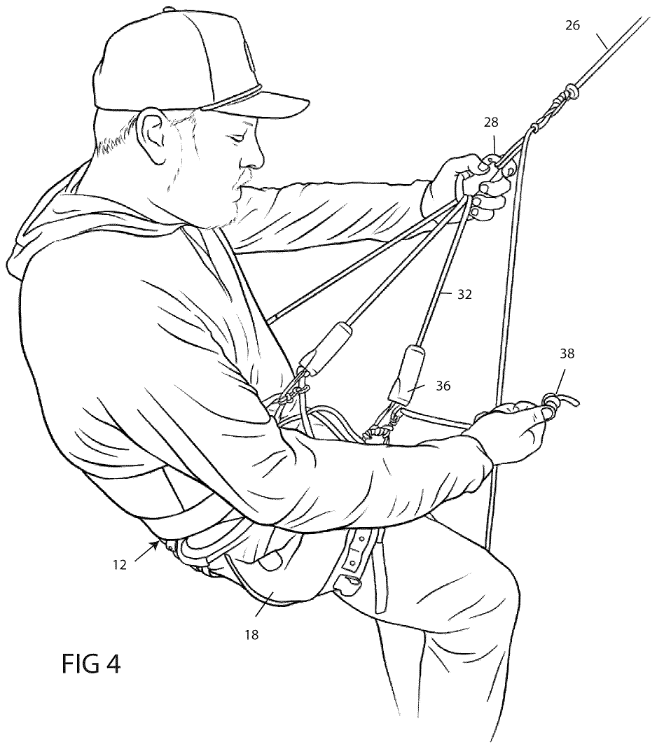

FIGS. 4-7 show further features of the assembly 10 and methods of adjustment that the user can make to the position of the saddle 12 while tethered in the tree T. These illustrations are exemplary and are not limiting as to all of the adjustments and positions that can be achieved by adjusting the bridge lines 30, 32. Generally, to adjust the position of the upper and/or lower portions 18, 20 of the saddle 12 (i.e., to raise or lower them), the user bodily adjusts the effective length of one or both bridge lines 30, 32 while supported in the saddle 12. This has the effect of lengthening or shortening the bridge line leads 30L, 30R and 32L, 32R equally on either side of the apex of the lines at carabiner 28. The bridge lines 30, 32 are free to slide through the carabiner and are unencumbered by one another so that adjustment to the length of one of the upper or lower bridge line does not impact the other bridge line (they slide relative to one another) and the weight of the user causes the adjusted line to slip relative to the carabiner 28 and equalize the length adjustment and thus weight distribution equally on either side of the carabiner. For example, if the user were to shorten the upper bridge line 30 by drawing up the tag end 38 by 4 inches, the net change in the upper bridge loop would be 4 inches, but it would be divided by a 2 inch decrease of the left bridge line lead 30L and a 2 inch decrease of the right bridge line lead 30R. Increases in bridge line length are also divided equally between the left and right bridge line leads. It will be appreciated that the length adjustment results in the bridge line sliding through the carabiner 28 and that because the bridge lines are not sewn or otherwise fixed to one another each bridge line is able to slide relative to the other bridge line to achieve balanced adjustment between the left and right leads.

In FIG. 4, the user is shown shortening the lower bridge line 32. He does this by grasping a tag end 38 of the lower bridge line 32 and then drawing or lifting it generally upward, which slides the bridge line 32 through the friction hitch knot 36 to decrease the size of the associated bridge line loop, thus lifting the lower saddle portion 18 and the user's thighs and hips toward the carabiner 28. A tender 37 is secured to the lower anchor loop 24R of the lower portion 18 of the saddle 12 and receives the tag end 38 of the lower bridge line 32 through a hole of the tender such that when the tag end 38 is lifted it tensions the tender 37 relative to the saddle 12 and causes the friction hitch knot 36 to compress against the tender 37 under the lifting force to release its gripping constriction force on the lower bridge line 32 to enable the lower bridge line 32 to slide through the friction hitch knot 36 and hole of the tender 37 to shorten the length of the lower bridge loop 32. The decrease in length is split between the left and right bridge line leads of the lower bridge line 32 as the lower bridge line 32 slides across the carabiner 28. In this illustration the upper bridge line was not adjusted and the lower bridge line 32 was slid during adjustment relative to the upper bridge line.

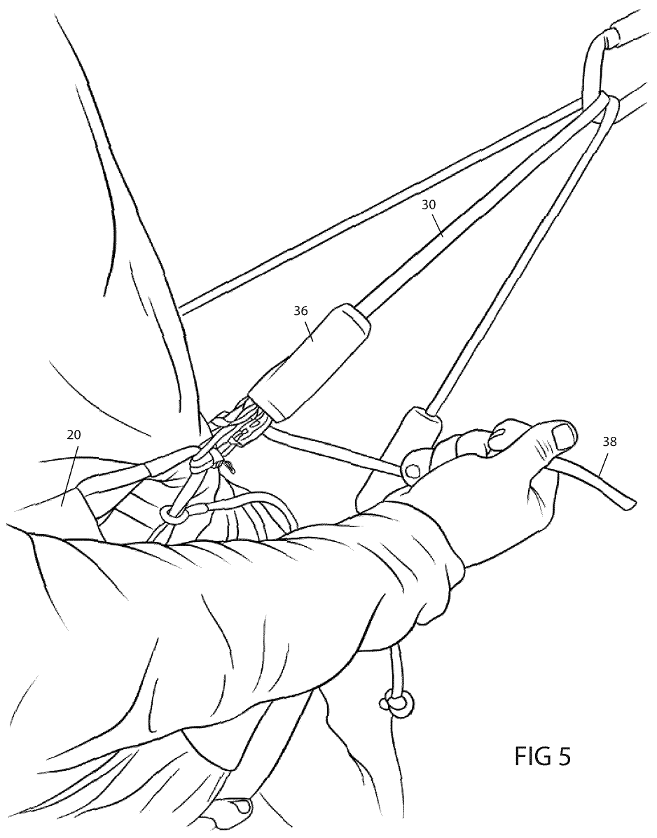

FIG. 5 illustrates the user shortening the upper bridge line 30 by similarly grasping the tag end 38 of the upper bridge line 30 and lifting to slide the line 30 through the associated friction hitch 36 which tilts the upper portion 20 forwardly toward the carabiner 28. The friction hitch 36 is shown in this illustration with an optional sleeve or cover which may be provided to assist the user in loosening the friction hitch when it is desired to lengthen the bridge line 30. A tender 37 is preferably provided on the upper portion 20 of the saddle 12 in the same manner as on the lower portion 18 but secured to the upper anchor loop 22L. The upper and lower bridge lines 30, 32 and their adjustment devices 36 may be identical in construction and operation.

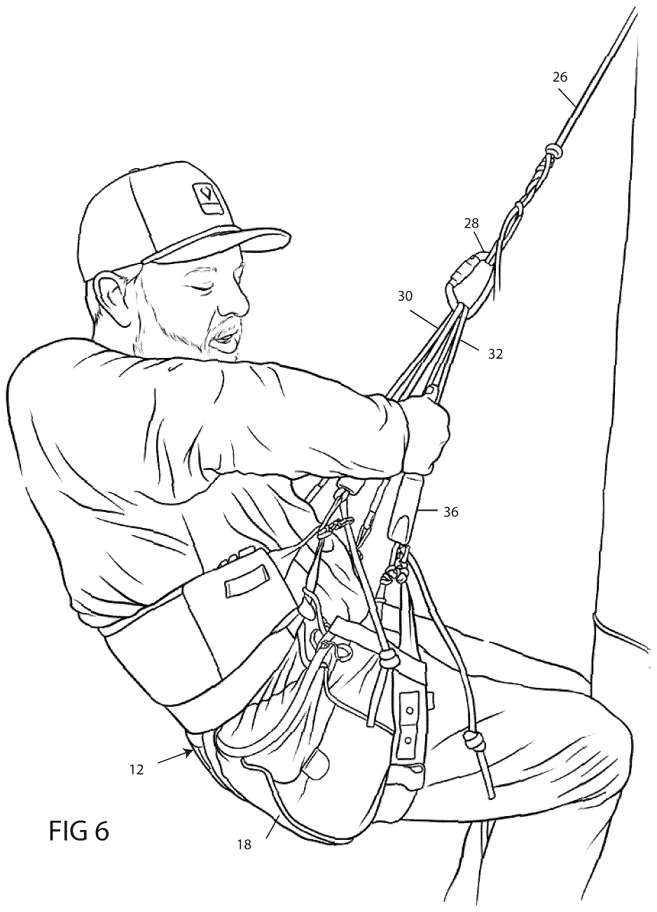

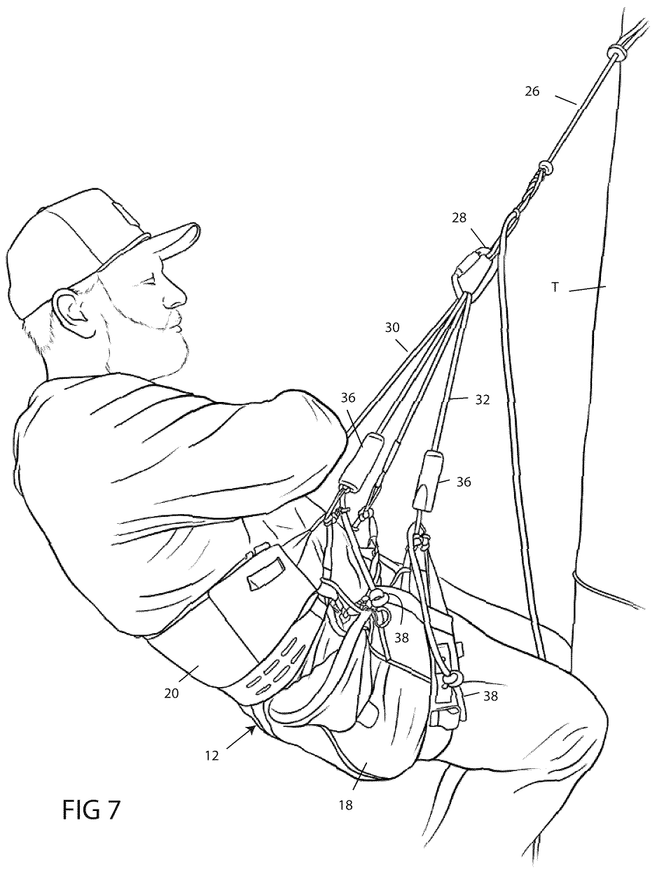

FIG. 6 illustrates the user increasing the effective length of the lower bridge line 32. The user pushes down on the friction hitch knot 36 (understood to be beneath the illustrated optional cover) of the lower bridge line 32 which causes the constriction knot 36 to loosen its grip about the bridge line 32 in a controlled manner that allows the line 32 to slide with controlled friction through the knot 36 in the other direction which increases the effective length of the lower bridge line loop 32 and thus dropping the lower saddle portion 18 in a direction away from the carabiner 28. The increase in length of the loop 32 is taken up equally between the left and right bridge line leads 32L and 32R as happened with the shortening of the length. It will be understood that the same adjustment steps may be followed for the upper bridge line 30 in order to adjust the upper bridge line 30 to move the upper saddle portion and user's back toward or away from the carabiner 28. FIG. 7, for example, illustrates the upper portion 20 adjusted to recline rearwardly away from the carabiner 28 as a result of the user having pushed down on the associated friction knot 36 (beneath the optional cover) of the upper bridge line 30 to lengthen the upper bridge line 30. It will be appreciated that the user can manipulate the upper and lower bridge lines 30, 32 to tilt back or forward, increase or decrease hip angle, to move toward or away from the tree all while supported in the saddle 12 in order to relieve any pressure points or maneuver to a position advantageous for viewing or hiding from wild game or to shoot a weapon. The bridge lines 30, 32 are individually adjustable and individually slidable relative to the carabiner 28 to provide quick, smooth, extensive adjustment in the position of the saddle 12 while in use. The individual adjustability of the upper and lower bridge lines 30, 32 synergistically offers the user a near endless combination of support positions that would not be possible with a single bridge line nor with bridge lines that are ganged together in fixed fashion. The effect for the user is similar to the support offered by a recliner chair although with this saddle 12 the user is able to select a near endless range and combination of support positions. The large triangulation offered by the dual bridge lines 30, 32 also greatly increases the range of movement compared to conventional bridge line adjustments since with this system the user can move the upper and lower parts of the saddle 12 as close to as far away from the tree as desired without reaching the limit of adjustability. There are no impediments to the shortening or lengthening of the bridge lines except for their rope length. It can be appreciated that extreme positions could be achieved that would place the user near vertical to the tree or near horizontal to the tree and any combination of upright and reclining positions in between.

The upper and lower bridge lines 30, 32 are preferably two distinct ropes or lines each having its own loop, but it is contemplated that the ropes could combine in to form a single or unified loop for connection with the carabiner. For example, the lines could be made of Amsteel and one line passed into and out of the other toward the middle such that a single loop portion results but which enables the lines 30, 32 to still slide relative to one another during length adjustment. It will be understood that the tag ends 38 of the upper and lower bridge lines 30, 32 can comprise terminal ends of the bridge lines or the tag ends could be interconnected (either as a continuation of one line into the next or via a knot or other connection).

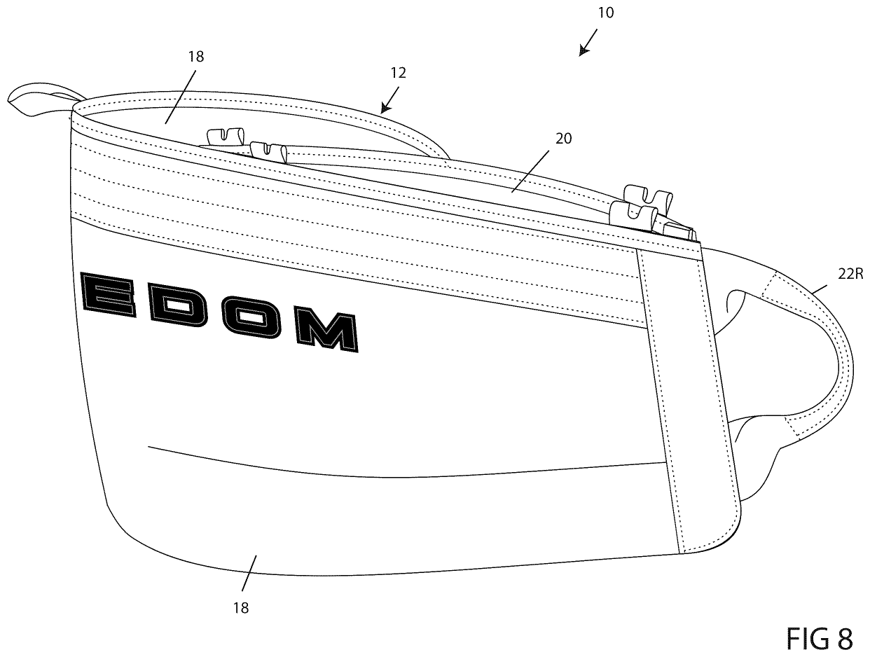

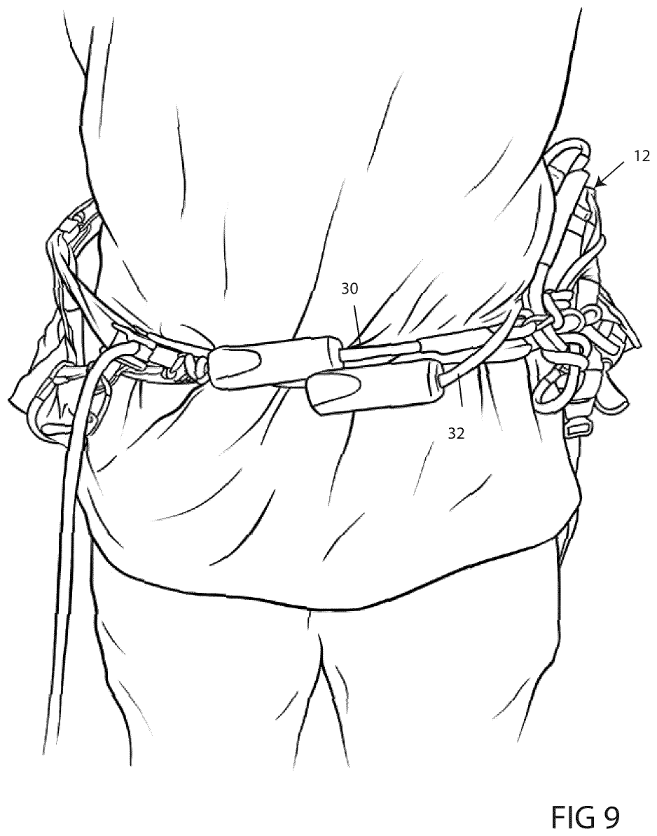

Turning now to FIG. 8-10, when the saddle is not in use in supporting the user tethered in a tree, the user may configure the saddle assembly 10 in a walking condition, wherein the leg straps 17 are unhooked and the lower portion 18 of the saddle 12 is folded upwardly and onto the upper portion 20 of the saddle 12 such that the former inside of the lower portion 18 now faces outward and wraps about the user's back side. The edges of the folded upper 20 and lower 18 panels may be provided with magnets which may be embedded in the fabric to releasably retain the panels in the folded condition. The folded panels 18, 20 may create a pouch or slot or pocket (like a taco shell) within the fold which can be used to store gear or other items. As shown in FIG. 9, the upper and lower bridge lines 30, 32 may be cinched tight about the user's waist to further support the folded saddle on the user and the tag ends 38 of the lines 30, 32 may be tucked into the fold pouch of the saddle 12. In this way, the saddle 12 is configured in a compact, clean, sleek, attractive form that resists snagging on brush or the like when walking to and from a hunting site and which doubles as added storage for gear and other items that might otherwise need to be carried or might hang loose and cause discomfort to the user when walking.

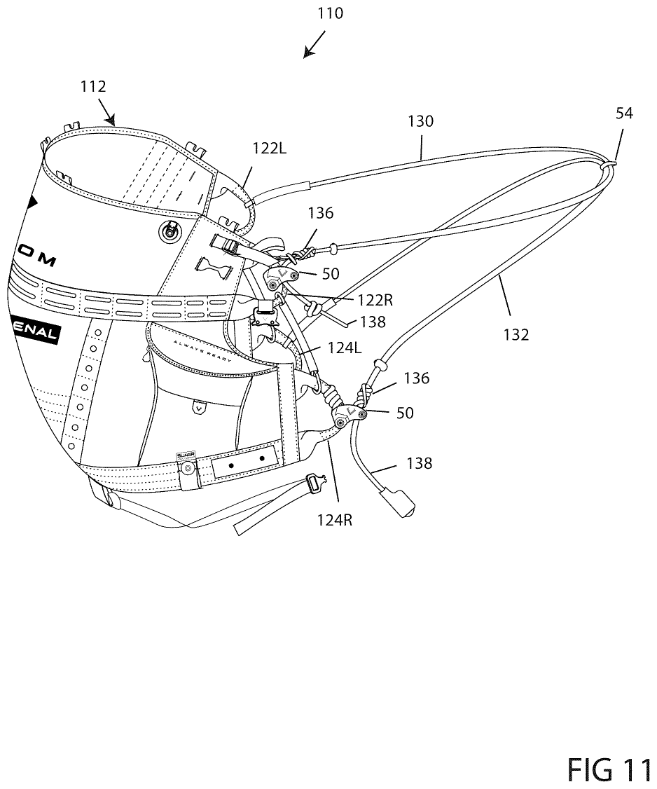

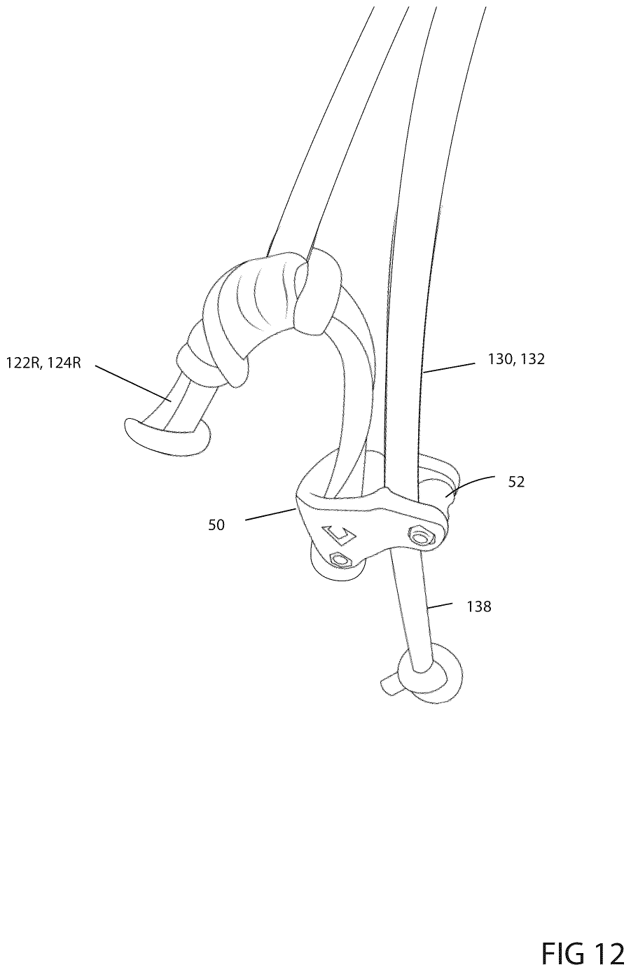

FIGS. 11 and 12 depict an alternative embodiment of the saddle assembly 110 that corresponds to the first embodiment 10 except that the tender 37 of each upper and lower length adjustment device 36 is replaced with a roller cam tender device 50 for the respective upper and lower bridge lines 130, 132. For clarity, reference numerals for components common to the first embodiment are increased by 100. As in the first embodiment, the upper and lower bridge lines 130, 132 each employ friction hitch knots 136 that, when constricted, immobilize the associated bridge line to prevent length adjustment and, when loosened, permit the line to slide with controlled friction through the knot 136 during shortening and lengthening.

In this embodiment, the plastic tenders with guide holes are replaced by cam roller tenders 50. As best seen in FIG. 12, each cam roller 50 includes a rear passage receiving the corresponding upper or lower anchor loop 122R, 124R to secure the tender to the upper and lower saddle portions 120, 118 of the saddle 112, and a front passage receiving the tag end 138 of the associated bridge line 130, 132. A roller wheel 52 is disposed in the front passage. When the tag end 138 is lifted to shorten the bridge line, the tag end wraps around the roller wheel 52 and rolls across it, thereby substantially reducing the lifting force otherwise required. Unlike a constricted guide opening that induces sliding friction and associated drag, the roller wheel 52 rotates under the wrap and pull of the tag end 138, effectively eliminating the drag component and facilitating smoother, lower-effort shortening. Apart from the substitution of the cam roller tenders 50, the structure and operation of the saddle assembly 110 are the same as in the first embodiment, and the foregoing description thereof is incorporated herein by reference.

The sleeve 54 gathers the bridge loops 132, 130 at or near their apexes where they are attachable to the carabiner 28 of the tether line 26, enabling the user to grasp and connect both loops to the carabiner in a single motion and providing confirmation that both loops are engaged. The sleeve 54 is preferably loosely fitted around the bridge loops 132, 130 to maintain their proximity while permitting the loops to slide relative to one another and relative to the sleeve 54, thereby preserving independent length adjustment and load balancing of each bridge line. The sleeve 54 further permits free sliding of the bridge loops 130, 132 through the carabiner 28 during length adjustment and when the user shifts position or leans to either side while in the saddle 112.

It will be understood that the above description is illustrative of embodiments of the invention and not limiting thereof.

1. A tree saddle assembly, comprising:
a saddle configured to wrap about a user for supporting the user while tethered to a tree by a tether line;
a bridge line assembly including a first bridge line forming a first loop extending forward of the saddle with an apex configured for attachment to the tether line and coupled to a first set of left and right attachment locations on a first portion of the saddle, and a second bridge line separate from the first bridge line forming a second loop extending forward of the saddle with an apex configured for attachment to the tether line and coupled to a second set of left and right attachment locations on a second portion of the saddle; and
wherein the first and second bridge line loops are independently adjustable in effective length to enable the user to selectively reposition of the first and second portions of the saddle relative to one another while tethered in the tree.

2. The assembly of claim 1, wherein when in use the first and second bridge line loops each support a fractional load of the user's weight which is balanced between the first and second bridge line loops, and wherein the weight load balance can be adjusted by adjusting the effective length of either or both of the bridge line loops.

3. The assembly of claim 2, wherein the first and second bridge line loops are slidable relative to one another at their apexes.

4. The assembly of claim 1, wherein the saddle is foldable to a compact transport position via magnetic closures and the first and second bridge line loops are adjustable to be drawn tight about a user's waist to support the saddle compactly about the users waist while walking.

5. The assembly of claim 1, wherein the first portion of the saddle is a lower portion that supports the upper thigh region of the user's body and the second portion of the saddle is an upper portion that supports the lower back region of the user's body.

6. The assembly of claim 5, wherein the saddle comprises one or more interconnected panels of flexible material.

7. The assembly of claim 1, wherein left and right loop portions are each fixed against adjustment on one of their respective left and right attachment locations and each include a length adjustment device provided at the other of their left and right attachment locations.

8. The assembly of claim 7, wherein the adjustment device for each of the first and second loop portions comprises a friction hitch fixed to the saddle and wrapped about the respective loop portion to firmly engage and hold the respective loop portion against sliding relative to the friction hitch when constricted and to enable sliding adjustment of the respective loop portion when loosened.

9. The assembly of claim 8, wherein the adjustment device for each of the loop portions further comprises a tender anchored with respect to the saddle and interacting with a tag end of the loop portion extending from the friction hitch for selectively engaging and loosening the friction hit in response to the user bodily lifting the tag end and sliding the tender into compressive loosening engagement with the friction hitch to effect shortening of the associated loop portion.

10. The assembly of claim 9, wherein the tender comprises a roller cam.

11. The assembly of claim 9 wherein the tag end of the first and second loop portions comprise either individual loose ends or where the ends are united.

12. The assembly of claim 1 wherein the first and second loop portions include an external connector that holds the two loops in close proximity to one another in the region of the apexes for ease of gathering and attaching the looped portions to a carabiner of the tether line, wherein the external connector enables the looped portions to slide relative to one another and relative to the carabiner in use and during length adjustment of the first and second looped portions.

13. The assembly of claim 1, including a belt line attachable about the waist of the user separately from the bridge line assembly.

14. A tree saddle assembly, comprising:
a saddle fabricated of one or more interconnected panels of flexible material configured to wrap behind the body of a user to provide weighted support to the user while tethered in the tree by a tether line, the saddle having at least an upper section and a lower section and extending between left and right sides that are presented on left and right sides of the user, respectively, when in use;
at least two bridge lines connecting the saddle to the tether line when in use, comprising an upper bridge line connected to the left and right sides of the upper section of the saddle and extending forward of the saddle in an upper loop connectable at apex thereof to the tether line when in use, and a lower bridge line connected to left and right sides of the lower portion of the saddle and extending forward of the saddle in a lower loop connectable at an apex thereof to the tether line, the upper and lower loops being free to slide relative to the tether line and to move relative to one another in use; and
wherein the upper and lower loops are adjustable in effective length independently of one another.

15. The assembly of claim 14, wherein the upper loop includes an upper length adjustment device and the lower loop includes a lower adjustment device.

16. The assembly of claim 15, wherein the upper adjustment device comprise an upper friction hitch and the lower adjustment device comprises a lower friction hitch.

17. The assembly of claim 16, wherein the upper adjustment device further comprises an upper cam roller cooperating with the upper friction hitch and the lower adjustment device further comprises a lower cam roller cooperating with the lower friction hitch.

18. The assembly of claim 15, wherein the upper loop is fixed against adjustment on either the left or right side of the upper section of the saddle and is adjustable on the other of the left and right sides of the upper section of the saddle; and wherein the lower loop is fixed against adjustment on either the left or right side of the lower section of the saddle and is adjustable on the other of the left and right sides of the lower section of the saddle.

19. The assembly of claim 15, wherein the upper section of the saddle includes left and right anchor loops connected to the upper loop and the lower section of the saddle includes left and right anchor loops connected to the lower loop; and wherein the upper and lower loops are adjustable from the one side of the saddle and fixed against adjustment on the other side of the saddle.

20. A method of adjusting the position of upper and lower sections of a tree saddle supporting a user while tethered from a tree by a tether line, the method comprising:
providing the saddle with at least two separate bridge lines including an upper bridge line fixed against adjustment at one to the left or right side of an upper section of the saddle and connected adjustably to the other right or left side of the saddle by an upper length adjustment device, and further providing the saddle with a lower bridge line separate from the upper bridge line that is fixed against adjustment at one end to the left or right side of a lower section of the saddle at a different location than the fixed end of the upper bridge line and connected adjustably to the other right or left side of the saddle by a lower length adjustment device at a different location than the location of the upper adjustment device;
attaching forward loops of the upper and lower bridge lines to a carabiner or other slidable support of the tether line such that the upper and lower tether lines are able to glide relative to the tether line and move relative to and independently of one another; and
manipulating the upper and lower adjustment device independently of one another so as to increase or decrease the effective lengths of the loops of the upper and lower bridges relative to the connection point with the tether line so as to move the upper and lower sections of the saddle closer to or further from the connection point to adjust the tile angle of the saddle relative to the tree, to adjust the angle between the upper and lower saddle sections, and to adjust the distribution of the user's weight between the upper and lower bridge lines.

21. The method of claim 20, wherein the upper and lower length adjustment devices are each operable from one side of the saddle only and comprise an upper friction hitch device and a lower friction hitch device that are operable in a locked condition to constrict about the respective upper and lower bridge lines to preclude length adjustment and further operable in an unlocked condition to permit sliding adjustment of the respective upper and lower bridge lines relative to the upper and lower friction hitches.
